(19) United States
(12) Patent Application Publication
(10) Pub. No.: US 2020/0311130 A1
(43) Pub. Date: Oct. 1, 2020

(54) SYSTEM AND METHOD FOR MANAGING DYNAMIC CONFIGURATION CHANGES IN SOFTWARE APPLICATIONS

(71) Applicant: Wipro Limited, Bangalore (IN)

(72) Inventors: Prakash Rathinasabapathy, Thiruchengodu (IN); Arun Kumar Subramanian, Annanur (IN)

(21) Appl. No.: 16/366,576

(22) Filed: Mar. 27, 2019

(30) Foreign Application Priority Data
Mar. 27, 2019 (IN) 201941012074

(51) Int. Cl. G06F 16/84; G06F 16/2453; G06F 16/835

(52) U.S. Cl. CPC G06F 16/86; G06F 16/8358; G06F 16/2453

(57) ABSTRACT

A method and system for managing dynamic configuration changes in software applications is disclosed. The method includes converting an application object data from a first data format to a second data format readable by a framework. The method further includes creating a first table that includes mapping between an entity key, a plurality of queries, and a blueprint each associated with the application object. The blueprint is in the second data format. The method includes creating a second table that includes mapping between the entity key, at least one attribute associated with the application object, and at least one column in a database. The method further includes creating a mapped operation by mapping the application object data to a query, the blueprint, and a column from the at least column, based on the first table and the second table. The method includes executing the mapped operation on the database.

### TECHNICAL FIELD

This disclosure relates generally to software applications, and more particularly to system and method for managing dynamic configuration changes in software applications.

### BACKGROUND

At present most software applications, for example, desktop/laptop applications or mobile applications, need to interact with a database for Create, Read, Update and Delete (CRUD) operations. Software applications interact with the database via frameworks, such as, query framework or Object Relation Mapping (ORM) frameworks. For the software application to be operational, it is configured with necessary information, for example, table details and attribute details before the software application is deployed. Once the deployment is completed, there is no provision to modify the configuration details. For example, there may be a software application with ORM and the software application may have a mapping file or annotation base configuration with table name, column name, and User Interface (UI) attribute name etc. Once the software application is deployed for use, there is no provision to modify any of the configuration. Moreover, developers do not retain any control over the configuration. Thus, if any changes in the database configuration are required to be made, then the issues in configuration mapping or any other runtime issues can be effected only after a release (up-gradation), which may happen on a quarterly or monthly basis, as the schedule may have been fixed. As a result, waiting time for effecting any change in configuration is considerable and requires code changes at the configuration level each time to ensure the reported issues are fixed.

Further, conventional frameworks also have performance issues when processing high volume of data or huge number of tables in a software application. For example, if there is any issue in the query that has been fired or if there is an issue in the mapping, then the software application will load unwanted data which may lead to crash of the software application or the software application may behave absurdly.

In a conventional system, object model formation is based upon data table semantic configuration information. Thus, there may be an unwanted data that may also reside within the object. For example, in the conventional system, if a table has 50 columns, all 50 column information may be uploaded, even if only one column is required. This leads to overhead to the software application.

### SUMMARY

In one embodiment, a method for managing dynamic configuration changes in software applications is disclosed. The method includes converting, by a configuration device, an application object data associated with an application object from a first data format to a second data format readable by a framework. The application object data is used to retrieve data from a database for a software application. The method further includes creating, by the configuration device, a first table comprising mapping between an entity key associated with the application object, a plurality of queries associated with an application object, and a blueprint associated with the application object. The blueprint is in the second data format. The method includes creating, by the configuration device, a second table comprising mapping between the entity key associated with the application object, at least one attribute associated with the application object, and at least one column in the database. The method further includes creating a mapped operation, by the configuration device, by mapping the application object data converted into the second data format to a query from the plurality of queries, the blueprint associated with the application object, and a column from the at least column, based on the first table and the second table. The method includes executing, by the configuration device, the mapped operation on the database.

In another embodiment, a system for managing dynamic configuration changes in software applications is disclosed. The system includes a processor and a memory communicatively coupled to the processor, wherein the memory stores processor instructions, which, on execution, causes the processor to convert an application object data associated with an application object from a first data format to a second data format readable by a framework, wherein the application object data is used to retrieve data from a database for a software application. The processor instructions further causes the processor to create a first table comprising mapping between an entity key associated with the application object, a plurality of queries associated with an application object, and a blueprint associated with the application object, wherein the blueprint is in the second data format. The processor instructions causes the processor to create a second table comprising mapping between the entity key associated with the application object, at least one attribute associated with the application object, and at least one column in the database. The processor instructions further causes the processor to create a mapped operation by mapping the application object data converted into the second data format to a query from the plurality of queries, the blueprint associated with the application object, and a column from the at least column, based on the first table and the second table. The processor instructions causes the processor to execute the mapped operation on the database.

In yet another embodiment, a non-transitory computer-readable storage medium is disclosed. The non-transitory computer-readable storage medium has instructions stored thereon, the set of computer-executable instructions causing the computer comprising one or more processors to perform steps comprising converting an application object data associated with an application object from a first data format to a second data format readable by a framework, wherein the application object data is used to retrieve data from a database for a software application; creating a first table comprising mapping between an entity key associated with the application object, a plurality of queries associated with an application object, and a blueprint associated with the application object, wherein the blueprint is in the second data format; creating a second table comprising mapping between the entity key associated with the application object, at least one attribute associated with the application object, and at least one column in the database; creating a mapped operation by mapping the application object data converted into the second data format to a query from the plurality of queries, the blueprint associated with the application object, and a column from the at least column, based on the first table and the second table; and executing the mapped operation on the database.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for managing dynamic configuration changes in software applications, in accordance with an embodiment.

FIG. 2 is a block diagram illustrating various modules within a memory of a configuration device configured to manage dynamic configuration changes in software applications, in accordance with an embodiment.

FIG. 3 illustrates a flowchart of a method for managing dynamic configuration changes in software applications, in accordance with an embodiment.

FIG. 4 illustrates a flowchart of a method for retrieving data from a database for a software application that has undergone configuration changes, in accordance with an embodiment.

FIG. 5 illustrates a database table comprising data and first and second tables used to retrieve data from the database table for a software application that has undergone configuration changes, in accordance with an exemplary embodiment.

FIG. 6 is a block diagram of an exemplary computer system for implementing embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present disclosure is a framework will provide a provision to configure both Object and DB information as a JSON format in database, So it will be easy to maintain and if application required any specific information in the table, it's very simple to pick the corresponding date alone, without overhead the application (loading all columns),

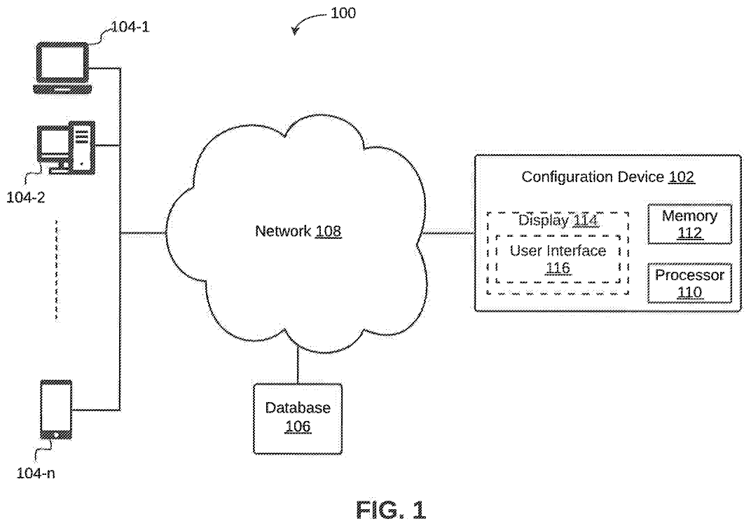

Additional illustrative embodiments are listed below. In one embodiment, a system 100 for managing dynamic configuration changes in software applications is illustrated in the FIG. 1, in accordance with an embodiment. The system 100 includes a configuration device 102 configured to manage dynamic configuration changes in a software application. The software application may be installed in one or more of computing devices 104-1 to 104-n (collectively referred to as a plurality of computing devices 104). The software application installed on one or more of the plurality of devices 104 may perform various operations on a database 106. Examples of operations may include, but are not limited to retrieving data from the database 106, inserting new data into the database 106, editing data in the database 106, or removing data from the database 106. The database 106 may be communicatively coupled to each of the plurality of computing devices 104, via a network 108. The network 108 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

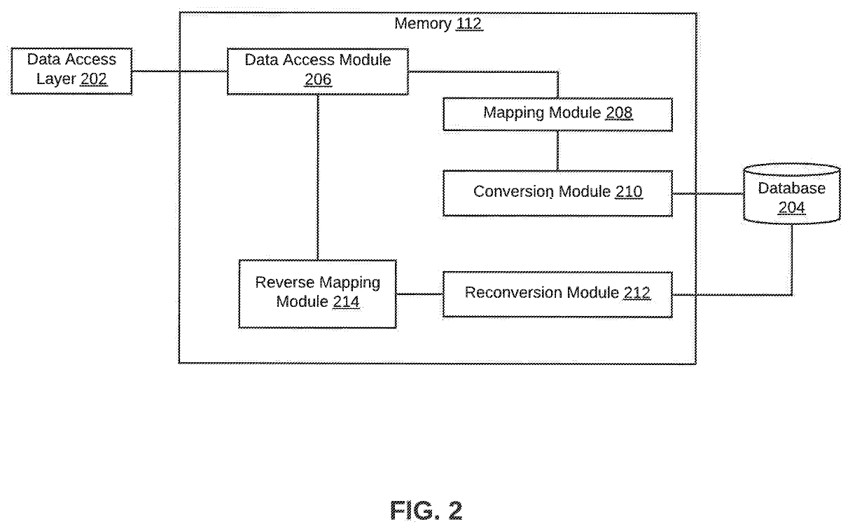

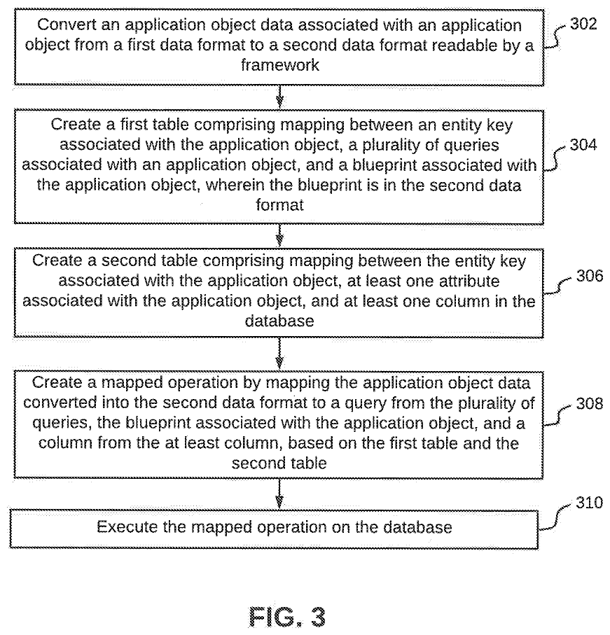

The configuration device 102 may provide a framework that may communicate or integrate with the software application installed on one or more of the plurality of computing devices 104, The framework may then facilitate communication of the software application with the database 106. The framework may receive data from a data access layer associated with the software application. The data access layer is mapped to database information (associated with the database 106) and operations that may be required to be performed in order to achieve desired results, i.e., one or more of retrieval of data, modification of data, deletion of data, or insertion of new data in the database 106. The framework in the configuration device 102 receives database operation information along with data from the data access layer and converts the same for providing to the database 106. In a similar manner, the framework converts a result set received from the database 106 before providing the same to the data access layer. This is further explained in detail in conjunction with FIG. 2 and FIG. 3. It will be apparent to a person skilled in the art that the framework may be installed in each of the plurality of computing device 104 along with the software application.

To this end, the configuration device 102 may include a processor 110 that is communicatively coupled to a memory 112, which may be a non-volatile memory or a volatile memory. Examples of the non-volatile memory, may include, but are not limited to a flash memory, a Read Only Memory (ROM), a Programmable ROM (PROM), Erasable PROM (EPROM), and Electrically EPROM (EEPROM) memory. Examples of the volatile memory may include, but are not limited Dynamic Random Access Memory (DRAM), and Static Random-Access memory (SRAM). The memory 112 may further include various modules that enable framework in the configuration device 102 to manage dynamic configuration changes in the software application. These modules are explained in detail in conjunction with FIG. 2. The configuration device 102 may further include a display 114 having a User Interface (UI) 116 that may be used by a user or an administrator to provide various inputs to the configuration device 102. The display 114 may further be used to display a result of the analysis performed by the configuration device 102. The functionality of the configuration device 102 may alternatively be configured as a distributed system, such that each module within the memory 112 may be implemented as a separate system.

Referring to FIG. 2, a block diagram of various modules within the memory 112 of the configuration device 102 configured to perform language independent iterative learning mechanism for NLP tasks is illustrated, in accordance with an embodiment. A data access layer 202 sends an application object that is associated with a software application to a framework in the configuration device 102. The application object corresponds to an operation or action to be performed on a database 204.

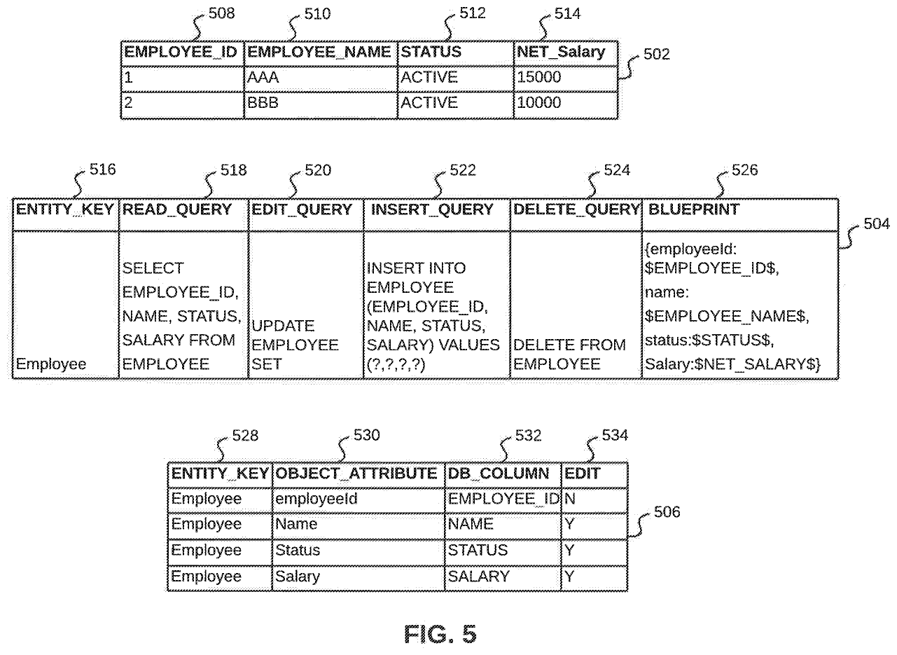

The application object may be in a first data format. Examples of the first data format may include, but are not limited to web application data transfer formats, such as, Extensible Markup Language (XML) or Hypertext Markup Language (HTML). The application object is received by a data access module 206 that converts the application object data within the application object to a second data format (or a component) that is understandable by the framework. The data access module 206 performs the conversion by means of object mapping, such that, the application object data can be further processed. The data access module 206 may also convert result set received from the database 204 from the second data format to the first data format before sending the same to the data access layer 202, so that the received result set may be comprehended by a user. This is further explained in detail in conjunction with FIG. 3 and FIG. 5.

After converting the application object data from the first data format to the second data format, the data access module 206 sends the application object data to a mapping module 208. The mapping module 208 map the application object data with configuration information associate with the database 204 as well as table column mapping. The configuration information may also include Create, Read, Update and Delete (CRUD) operation query details that are required for performing appropriate actions or operations on the database 204. The mapping module 208 stores the application object data in the database 204 by means of column mapping, so that, the configuration details may be changed dynamically. For example, the application entity attribute ‘A’ may be mapped to the column ‘B’. After some time, application entity attribute ‘A’ may be mapped to the column ‘C’ instead of ‘B’. In this case, there is no need to make any change at the code level of the software application. It is a simple change that may be performed by updating configuration details in the database 204 dynamically (on the fly). This is further explained in detail in conjunction with FIG. 3 and FIG. 5.

A conversion module 210 receives the mapped data as input from the mapping module 208 and converts the received information into database query based on user requirements. The database query generated after conversion performs the required action/operation on the database 204 and correspondingly cleans up resources (release of database connections) that have been used to run the query. This ensures that execution of database queries takes place in a quick and efficient manner while handling high volumes of data. The conversion module 210 may also perform marshalling and un-marshalling of application object. During marshalling, the conversion module 210 converts an application object from the first data format to the second data format (or a component understandable by the framework). During un-marshalling the conversion module 210 converts results retrieved from the database 204 in the second data format to an application object in the first data format, such that, the same can be read by the data access layer 202. This is further explained in detail in conjunction with FIG. 3 and FIG. 5.

A reconversion module 212 receives results retrieved from the database 204 and converts the result to into the second data format (or a component understandable by the framework). The reconversion module 212 then provides the converted result set to a reverse mapping module 214 for further processing. The reverse mapping module 214 receives the converted data and maps the converted data to the configuration information used in the mapping module 208. Thereafter, the reverse mapping module 214 provides the converted data to the data access module 206, which further shares the same with the data access later 202, post conversion to the first data format. This is further explained in detail in conjunction with FIG. 3 and FIG. 5.

Referring now to FIG. 3, a flowchart of a method for managing dynamic configuration changes in software applications is illustrated, in accordance with an embodiment. The data access layer associated with a software application sends an application object data, which is associated with a software application, to a framework in the configuration device 102. The application object data is associated with an application object and is used to retrieve data from the database 106 for the software application. The application object data may be received in response to a user requirement generated at the software application. In other words, the application object data is shared by the software application to retrieve data from the database 106. The application object, for example, may be structured as depicted in 1 below:

Employee {

| String employeeId; | |
|---|---|
| String name; | |
| String status; | ... (1) |

Double salary;

}

At step 302, the configuration device 102 converts the application object data from a first data format to a second data format that is readable by a framework. The first data format is native to the data access layer and examples may include web application data transfer formats, such as, Extensible Markup Language (XML) or Hyper-Text Markup Language (HTML). The second data format may be associated with different components and is understandable by the framework by means of object mapping so that further processing on the application object data may be performed.

At step 304, the configuration device 102 creates a first table that includes mapping between an entity key associated with the application object, a plurality of queries associated with the application object, and a blueprint associated with the application object. The entity key, for example, may be a primary key of a table within the database 106. The plurality of queries may include, but are not limited to a create query, a read query, an update query, and a delete query. The first table, for example, may include skeleton queries that are associated with each of the plurality of queries. This is further explained in detail in conjunction with the exemplary embodiment given in FIG. 5.

By creating the table, the configuration device 102 maps the received application object data with configuration information pertaining to the database 106 and a relevant table (at column level) in the database 106. The configuration information may also include (Create, Read, Update and Delete) CRUD operation query details, which may be used to perform appropriate operations on the database 106. In other words, the application data object detail is stored in the database 106 by means of column mapping, such that, the configuration details may be changed dynamically. For example, initially an application entity attribute ‘A’ may be mapped to a column ‘B.’ Subsequently, the application entity attribute ‘A’ may be mapped to the column ‘C’ instead of ‘B.’ Thus, as a result of the mapping, there may be no need to make any changes at the code level for the software application. A simple change may be performed by dynamically updating configuration details in the database 106. The blueprint stored in the first table is in the second data format, which is readable by the framework. The blueprint may be a JavaScript Object Notation (JSON) blueprint, for example. In other words, the blueprint of the application object data is in the form of a component that is identifiable and readable by the framework. This is further explained in detail in conjunction with the exemplary embodiment given in FIG. 5.

At step 306, the configuration device 102 creates a second table that includes mapping between the entity key associated with the application object, one or more attributes associated with the application object, and one or more columns in the database 106. By way of an example and referring back to the application object structure given in 1 above, the one or more attributes associated with the application object may include employeelD, name, status, and salary. In continuation of this example, one or more column names may also include EMPLOYEE_ID, NAME, STATUS, and SALARY. This is further explained in detail in conjunction with FIG. 5.

Based on the first table and the second table, the configuration device 102 may create a mapped operation at step 308. The mapped operation may be created by mapping the application object data (converted into the second data format) to a query from the plurality of queries, the blueprint associated with the application object, and a column from the one or more columns. By way of an example, the application object data may include details or specifics associated with employeelD, name, status, or salary. This is further explained in detail in conjunction with the exemplary embodiment of FIG. 5. The mapped operation may include one or more of a create operation, a read operation, an update operation, and a delete operation. The create operation may be used to add new data to the database 106, the read operation may be used to retrieved data from the database 106, the update operation may be used to update data in the database 106, and the delete operation may be used to delete data from the database 106. Since the application object data and the blueprint associated with the application object are in the second data format, the mapped operation that includes the query along with name of the one or more columns is also in the second data format. The framework can thus execute the mapped operation.

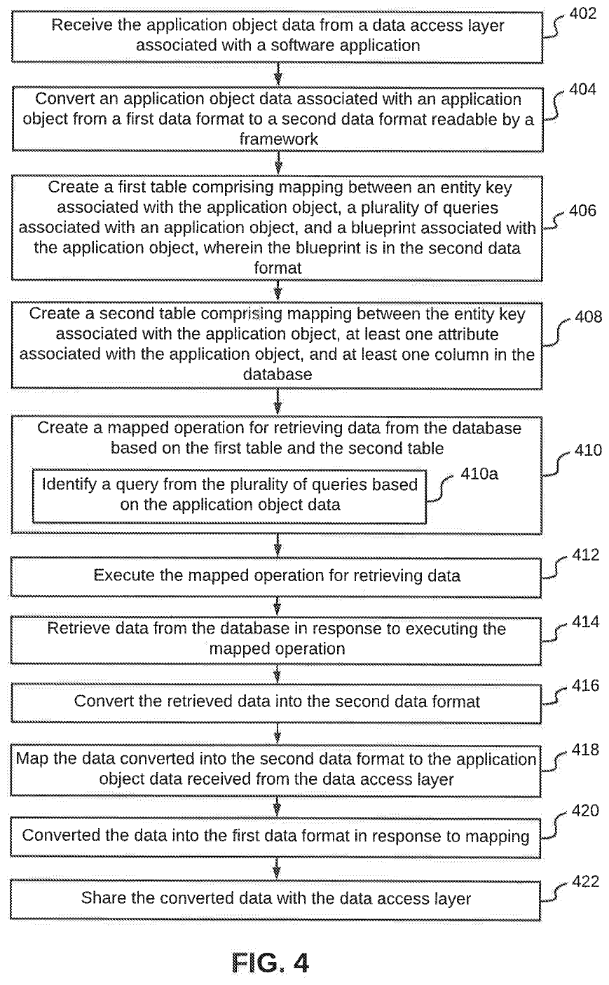

At step 310, the configuration device 102 executes the mapped operation on the database 106. In other words, one or more of the create operation, the read operation, the update operation, and the delete operation may be performed on the database 106. When the mapped operation is the read operation, data may be retrieved from the database 106, as a result of executing the read operation on the database 106. The data so retrieved is converted to a second data format (or the component) that is readable or understandable by the framework. The data converted into the second data format is then mapped back to the application object data received from the data access layer 202 using the first table and the second table. After mapping to the application object data, the data is converted into the first data format and sent to the data access layer 202. This is further explained in detail in conjunction with FIG. 4.

Referring now to FIG. 4, a flowchart of a method for retrieving data from a database for a software application that has undergone configuration changes is illustrated, in accordance with an embodiment. At step 402, an application object data associated with an application object is received. The application object data is used to retrieve data from the database 106 for the software application. The application object data may be received in response to a user requirement generated at the software application. At step 404, the application object data is converted from a first data format to a second data format readable by a framework. The application object data is used to retrieve data from a database for a software application. At step 406, a first table is created that includes mapping between an entity key associated with the application object, a plurality of queries associated with an application object, and a blueprint associated with the application object. At step 408, a second table is created that includes mapping between the entity key associated with the application object, one or more attributes associated with the application object, and one or more columns in the database. The steps 402 to 408 have been explained in detail in conjunction with FIG, 3.

At step 410, a mapped operation for retrieving data from the database 106 is created based on the first table and the second table. To this end, at step 410 a, a query from the plurality of queries is identified from the first table, based on the application object data. The mapped operation for retrieving data may be created by mapping the application object data to a read query from the plurality of queries. The application object data is also mapped to the blueprint associated with the application object, and a column from the one or more columns. By way of an example, the application object data may include details or specifics associated with employeelD, name, status, or salary, for retrieval of the specific data. This is further explained in detail in conjunction with the exemplary embodiment of FIG. 5.

At step 412, the mapped operation for retrieving data from the database 106 is executed. In response to execution of the mapped operation for retrieving data, data is retrieved from the database 106 at step 414. At step 416, the retrieved data is converted into a second data format (or the component) that is readable or understandable by the framework, At step 418, the data converted into the second data format is then mapped back to the application object data received from the data access layer 202 based on the first table and the second table. After mapping to the application object data, at step 420, the data is converted into the first data format. At step 422, the retrieved data that has been converted into the first data format is shared with the data access layer 202. In other words, the retrieved data is converted to a web application data transfer formats, such as, XML or HTML. This is further explained in detail in conjunction with FIG. 5.

Referring now to FIG. 5, a database table 502 comprising data and first and second tables 504 and 506 that are used to retrieve data from the database table 502 for a software application that has undergone configuration changes is illustrated, in accordance with an exemplary embodiment. The database 106 may include the database table 502. The database table 502 may include an employee_ID column 508 that includes details of ID associated with an employee in a given row, an employee_name column 510 that includes name of the employee in the given row, a status column 512 that employment status of the employee in the given row, and a net_salary column 514 that includes salary of the employee in the given row. The software application may access the database table 502, via the framework in the configuration device 102, in order to perform one or more operations that may include, but are not limited to reading data from the database table 502, writing data to the database table 502, deleting data from the database table 502, or editing data in the database table 502.

The configuration device 102 may create the first table 504 within the mapping 208. The first table 504 includes an entity_key column 516, a read_query column 518, an edit_query column 520, an insert_query column 522, a delete_query column 524, and a blueprint column 526, The entity_key column 516 includes a primary key that is used to retrieve data from the database table 502. The first table 504 includes skeleton queries associated with different types of queries or operations that may be executed by the framework on the database table 502. The read_query column 518 may include a skeleton query associated with a read query, the edit_query column 520 includes a skeleton query associated with an edit query, the insert_query column 522 includes a skeleton query associated with an insert query, and the delete_query column 524 includes a skeleton query associated with a delete query. Further, in the first table 504, the blueprint column 526 includes a blueprint of an application object that was received from the data access layer 202. The blueprint is in the second data format (or a component format) that is understandable by the framework. The application object determines the operation to be performed on the database table 502. Thus, the first table 504 includes all query details associated with the CRUD operations for an employee.

The configuration device 102 may also create the second table 506 in the mapping module 208. The second table 506 may also include an entity_key column 528 that includes a primary key that is used to retrieve data from the database table 502. The second table 506 further includes an object_attribute column 530 that incudes attributes associated with the application object received from the data access later 202. The object_attribute column 530 includes the following object attributes: employeelD, name, status, and salary. The second table 506 further includes a DB. column 532 that includes names of the columns from the database table 502 that are linked to the corresponding object attributes in the object_attribute column 530. An edit column 534 depicts whether a corresponding column under the DB column 532 in the same row is editable or not.

In an embodiment, the framework may execute a read operation on the database table 502 based on the application object data received from the data access layer 202. The framework first converts the application object data into the second data format (or component understandable by the framework). The framework then extracts the read_query from the read_query column 518 and appends the read_query with the application object data post conversion. Thereafter, the framework executes the read_query on the database table 502. The results so retrieved from the database 106 are returned to the framework. Based on blueprint associated with the application object in the blueprint column 526, the framework may replace the “database column name string (i.e., $EMPLOYEE_ID$) with the corresponding column value. Thereafter, the framework may convert this into the first data format (i.e., the format of the application object) and send it back to the software application, via the data access layer 202. By way an example, the read_query may be executed on the database table 502 may be: “SELECT EMPLOYEE_ID, NAME, STATUS, SALARY FROM EMPLOY WHERE EMPLOYEE_ID=1.” After the framework has replaced Employee ID #1 in the blueprint given in the blueprint column 526, the retrieved results may be represented as given in 2 below:

{employeeId: 1, name:AAA, status:Active, Salary: 15000.00} (2)

The framework then converts the above data into the first data format (or the format of the application object) and sends it back to the software application via the data access layer 202.

In another embodiment, the framework may execute an insert operation on the database table 502 based on the application object data received from the data access layer 202, in order to insert new data into the database table 502. The framework first converts the application object data into the second data format (or component understandable by the framework). The framework then extracts the insert_query from the insert_query column 522 and appends the insert_query with the application object data post conversion to the second data format. Thereafter, the framework executes the insert_query on the database table 502. By way of an example, an insert_query may be represented by 3 given below:

INSERT INTO EMPLOYEE (EMPLOYEE _ID, NAME, STATUS, SALARY) VALUES (3, ‘DDD’,‘ACTIVE’, 2000) (3)

In yet another embodiment, the framework may execute an update operation on the database table 502 based on the application object data received from the data access layer 202, in order to update data already stored in the database table 502. The framework first converts the application object data into the second data format (or component understandable by the framework). The framework then extracts the edit_query from the edit_query column 520 and appends the edit_query with the application object data, based on the edit flag given in the edit column 534 for the database columns given in the DB_column 534. When the edit flag for a given database column in the DB_column 534 is “N,” it may be used for ‘where’ condition. By way of an example, an edit_query may be represented by 4 given below:

UPDATE EMPLOYEE SET EMPLOYEE_NAME=‘CCC’, STATUS=‘ACTIVE’, NET_SALARY=‘6000’ WHERE EMPLOYEE_ID=1 (4)

In response to this query, the details corresponding the employee with employee_ID as 1 are updated.

In another embodiment, the framework may execute a delete operation on the database table 502 based on the application object data received from the data access layer 202, in order to delete data already stored in the database table 502. The framework first converts the application object data into the second data format (or component understandable by the framework). The framework then extracts the delete_query from the delete_query column 524 and appends the delete_query with the application object data, based on the edit flag given in the edit column 534 for the database columns given in the DB_column 534. When the edit flag for a given database column in the DB_column 534 is “N,” it may be used for ‘where’ condition. By way of an example, a delete_query may be represented by 5 given below:

DELETE FROM EMPLOYEE WHERE EMPLOYEE_ID=1 (5)

In response to this query, the details corresponding the employee with employee_ID as 1 are deleted from the database table 502.

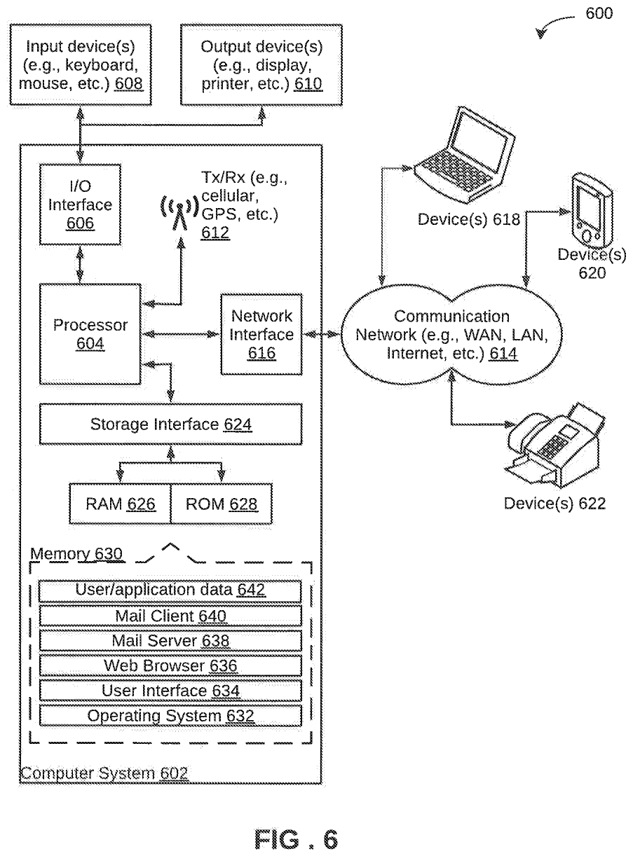

Referring now to FIG. 6, a block diagram of an exemplary computer system 602 for implementing various embodiments is illustrated. Computer system 602 may include a central processing unit (“CPU” or “processor”) 604. The processor 604 may include at least one data processor for executing program components for executing user or system-generated requests. A user may include a person, a person using a device such as those included in this disclosure, or such a device itself. The processor 604 may include specialized processing units such as integrated system (bus) controllers, memory management control units, floating point units, graphics processing units, digital signal processing units, etc. The processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® ti 4 processor, CELERON® processor or other line of processors, etc. The processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 604 may be disposed in communication with one or more input/output (I/O) devices via an I/O interface 606. The I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (for example, code-division multiple access (CDMA), high-speed packet access (HSPA+), global system for mobile communications (GSM), long-term evolution (LTE), WiMax, or the like), etc.

Using the I/O interface 606, the computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 610 may be a printer, fax machine, video display (for example, cathode ray tube (CRT), liquid crystal display (LCD), light-emitting diode (LED), plasma, or the like), audio speaker, etc. In some embodiments, a transceiver 612 may be disposed in connection with the processor 604. The transceiver 612 may facilitate various types of wireless transmission or reception. For example, the transceiver 612 may include an antenna operatively connected to a transceiver chip (for example, TEXAS® INSTRUMENTS WILINK WL 1286® transceiver, BROADCOM® BCM45501UB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, the processor 604 may be disposed in communication with a communication network 614 via a network interface 616. The network interface 616 may communicate with the communication network 614. The network interface 616 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. The communication network 614 may include, without limitation, a direct interconnection, local area network (LAN), wide area network (WAN), wireless network (for example, using Wireless Application Protocol), the Internet, etc. Using the network interface 616 and the communication network 614, the computer system 602 may communicate with devices 618, 620, and 622. These devices 618,620, and 622 may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO DS® gaming console, SONY® PLAYSTATION® gaming console, etc.), or the like. In some embodiments, the computer system 602 may itself embody one or more of these devices 618, 620, and 622.

In some embodiments, the processor 604 may be disposed in communication with one or more memory devices (for example, RAM 626, ROM 628, etc.) via a storage interface 624. The storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 630 may store a collection of program or database components, including, without limitation, an operating system 632, user interface application 634, web browser 636, mail server 638, mail client 640, user/application data 642 (for example, any data variables or data records discussed in this disclosure), etc. The operating system 632 may facilitate resource management and operation of the computer system 602. Examples of the operating systems 632 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT® , UBUNTU®, KUBUNTU®, etc.), IBM® OS/2 platform, MICROSOFT® WINDOWS® platform (XP, Vista/6/8, etc.), APPLE® IOS® platform, GOOGLE® ANDROID® platform, BLACKBERRY® OS platform, or the like. The user interface 634 may facilitate display, execution, interaction, manipulation, or operation of program components through textual or graphical facilities. For example, the user interface 634 may provide computer interaction interface elements on a display system operatively connected to the computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, the computer system 602 may implement a web browser 636 stored program component. The web browser 636 may be a hypertext viewing application, such as MICROSOFT INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. The web browsers 636 may utilize facilities such as AJAX, DHTML, ADOBE® FLASH® platform, JAVASCRIPT® programming language, JAVA® programming language, application programming interfaces (APis), etc. In some embodiments, the computer system 602 may implement a mail server 638 stored program component. The mail server 638 may be an Internet mail server such as MICROSOFT® EXCHANGE® mail server, or the like. The mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. The mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 602 may implement a mail client 640 stored program component. The mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, the computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide system and method for managing dynamic configuration changes in software applications. In the method and system, a framework is provided which can be used in any application which have interaction with the database and is capable of replacing present frameworks in use. The framework receives data from a data access layer of a software application and maps the same to database information and operations, which may be required to performed in order to achieve desired results. The framework converts the received database operation information along with the data in order to provide the same to the database. The result set received from the database undergoes conversion and reverse mapping in the framework, before it is provided to the data access layer.

In particular, the provided method benefits the organization implementing the same as well as the resources, as resource effort may be managed more effectively. As the provided method is more cost effective, revenue may increase substantially. The method may be used in any projects or opportunities where a software application deals with object and database components. As a result, the provided system may replace conventional Object Relationship Mapping products.

The claimed steps as discussed above are not routine, conventional, or well understood in the art, as the claimed steps enable the following solutions to the existing problems in conventional technologies, The conventional technologies lack in a programmatic framework that may allow dynamic mapping changes in the configuration based on user requirement as well as ensure the integrity of a software application when handling high volume of data. In the conventional technologies, once the deployment of a software application is completed, there is no provision to modify the configuration details. For example, there may be a software application with ORM and the software application may have a mapping file or annotation base configuration with table name, column name, and UI attribute name etc. Once the software application is deployed for use, there is no provision to modify any of the configuration. Moreover, developers do not retain any control over the configuration. Thus, if any changes in the database configuration are required to be made, then the issues in configuration mapping or any other runtime issues can be effected only after a release (up-gradation), which may happen on a quarterly or monthly basis, as the schedule may have been fixed. As a result, waiting time for effecting any change in configuration is considerable and requires code changes at the configuration level each time to ensure the reported issues are fixed.

The present disclosure pertains to providing a framework that would allow dynamic mapping changes in the configuration based on user requirement as well as ensure the integrity of the application when handling high volume of data. The frame wok of present disclosure may provide a provision to configure both object and database information as a JSON format in database. Thus, it is easy to maintain and if the software application requires any specific information from the table, it is very simple to pick the corresponding date alone, without causing an overhead on the software application (by loading all columns, for example). As a result, the framework may be light weight and faster and may retrieve data based upon user action and requirements.

The specification has described system and method for managing dynamic configuration changes in software applications. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing dynamic configuration changes in software applications, the method comprising:
converting, by a configuration device, an application object data associated with an application object from a first data format to a second data format readable by a framework, wherein the application object data is used to retrieve data from a database for a software application;
creating, by the configuration device, a first table comprising mapping between an entity key associated with the application object, a plurality of queries associated with the application object, and a blueprint associated with the application object, wherein the blueprint is in the second data format;
creating, by the configuration device, a second table comprising mapping between the entity key associated with the application object, at least one attribute associated with the application object, and at least one column in the database;
creating a mapped operation, by the configuration device, by mapping the application object data converted into the second data format to a query from the plurality of queries, the blueprint associated with the application object, and a column from the at least column, based on the first table and the second table; and
executing, by the configuration device, the mapped operation on the database.

2. The method of claim 1, wherein the mapped operation comprises at least one of a create operation, a read operation, an update operation, and a delete operation, wherein the read operation comprises retrieving data from the database.

3. The method of claim 2, further comprising:
converting the retrieved data into the first data format; and
sharing the converted retrieved data with the software application.

4. The method of claim 1, wherein the plurality of queries comprises a create query, a read query, an update query, and a delete query.

5. The method of claim 1, wherein the entity key in the first table and the second table is a primary key associated with the database, and wherein the mapped operation comprises the entity key.

6. The method of claim 1, wherein creating the mapped operation comprises identifying the query from the plurality of queries, based on the application object data.

7. The method of claim 1, further comprising receiving the application object data from a data access layer associated with the software application.

8. A system for managing dynamic configuration changes in software applications, the system comprising:
a processor; and
a memory communicatively coupled to the processor, wherein the memory stores processor instructions, which, on execution, causes the processor to:
convert an application object data associated with an application object from a first data format to a second data format readable by a framework, wherein the application object data is used to retrieve data from a database for a software application;
create a first table comprising mapping between an entity key associated with the application object, a plurality of queries associated with an application object, and a blueprint associated with the application object, wherein the blueprint is in the second data format;
create a second table comprising mapping between the entity key associated with the application object, at least one attribute associated with the application object, and at least one column in the database;
create a mapped operation by mapping the application object data converted into the second data format to a query from the plurality of queries, the blueprint associated with the application object, and a column from the at least column, based on the first table and the second table; and
execute the mapped operation on the database.

9. The system of claim 8, wherein the mapped operation comprises at least one of a create operation, a read operation, an update operation, and a delete operation, wherein the read operation comprises retrieving data from the database.

10. The system of claim 9, wherein the processor instructions further cause the processor to:
convert the retrieved data into the first data format; and
share the converted retrieved data with the software application.

11. The system of claim 8, wherein the plurality of queries comprises a create query, a read query, an update query, and a delete query.

12. The system of claim 8, wherein the entity key in the first table and the second table is a primary key associated with the database, and wherein the mapped operation comprises the entity key.

13. The system of claim 8, wherein creating the mapped operation comprises identifying the query from the plurality of queries, based on the application object data.

14. The system of claim 8, wherein the processor instructions further cause the processor to receive the application object data from a data access layer associated with the software application.

15. A non-transitory computer-readable storage medium having stored thereon, a set of computer-executable instructions causing a computer comprising one or more processors to perform steps comprising:
converting an application object data associated with an application object from a first data format to a second data format readable by a framework, wherein the application object data is used to retrieve data from a database for a software application;
creating a first table comprising mapping between an entity key associated with the application object, a plurality of queries associated with an application object, and a blueprint associated with the application object, wherein the blueprint is in the second data format;
creating a second table comprising mapping between the entity key associated with the application object, at least one attribute associated with the application object, and at least one column in the database;
creating a mapped operation by mapping the application object data converted into the second data format to a query from the plurality of queries, the blueprint associated with the application object, and a column from the at least column, based on the first table and the second table; and
executing the mapped operation on the database.
